(19) United States
(12) Patent Application Publication
(10) Pub. No.: US 2026/0110243 A1
(43) Pub. Date: Apr. 23, 2026

(54) MULTI-FREQUENCY AND MULTI-MODE ARRAY SONIC PROCESSING FOR CEMENT EVALUATION

(71) Applicant: Halliburton Energy Services, Inc., Houston, TX (US)

(72) Inventors: Ruijia Wang, Singapore (SG); Yao Ge, Singapore (SG); Frederico Heloui De Araujo, Rio de Janeiro (BR); Brenno Caetano Troca Cabella, Rio de Janeiro (BR); Xiang Wu, Singapore (SG)

(73) Assignee: Halliburton Energy Services, Inc., Houston, TX (US)

(21) Appl. No.: 19/206,629

(22) Filed: May 13, 2025

Related U.S. Application Data
(60) Provisional application No. 63/709,339, filed on Oct. 18, 2024.

(51) Int. Cl. E21B 47/005; G01V 1/18; G01V 1/50

(52) U.S. Cl. CPC E21B 47/005; G01V 1/186; G01V 1/50; E21B 2200/20

(57) ABSTRACT

Methods and systems of the present disclosure may use a multi-frequency-range and multi-mode guided-wave processing technique when determining whether a wellbore is safe to operate or is safe to plug and abandon. Methods of the present disclosure improve upon single frequency approaches that may yield unreliable determinations when eccentricities associated with a sensing assembly being offset from a center line of a casing is greater than a threshold level.

### CROSS-REFERENCE TO RELATED APPLICATIONS

This application claims priority benefit of U.S. Provisional Patent Application No. 63/709,339 filed Oct. 18, 2024, which is incorporate herein by reference.

### TECHNICAL FIELD

The present disclosure is generally directed to improving determinations made from collected data. More specifically, the present disclosure is directed to improving the operation of an acoustic sensing apparatus or system.

### BACKGROUND

Acoustic devices such as hydrophones may be deployed in a wellbore to collect sounds that may be used to identify whether a wellbore is safe to operate. Apparatuses like a hydrophone array may include many acoustic sensors or water-resistant microphones that sense wellbore sounds. Hydrophones deployed in a wellbore may sense noises from many sources or may sense sounds from a sound source that has traveled through one or more mediums (e.g., a wellbore casing or along a wellbore tube).

Casings that are installed in a wellbore must be cemented in place for the wellbore to function in a safe and environmentally conscious manner. Methods for verifying how well a wellbore casing is attached to strata that surround the wellbore may evaluate data (e.g., acoustic data) that was collected in the wellbore. Determinations must be made as to whether a new wellbore is safe to operate based on how well a wellbore casing is cemented to strata that surrounds that wellbore casing. Verifications must also be performed when a wellbore is put out of service.

### BRIEF DESCRIPTION OF THE DRAWINGS

In order to describe the manner in which the features and advantages of this disclosure can be obtained, a more particular description is provided with reference to specific implementations thereof which are illustrated in the appended drawings. Understanding that these drawings depict only exemplary implementations of the disclosure and are not therefore to be considered to be limiting of its scope, the principles herein are described and explained with additional specificity and detail through the use of the accompanying drawings.

FIG. 1A is a schematic diagram of an example logging while drilling wellbore operating environment, in accordance with various aspects of the subject technology.

FIG. 1B is a schematic diagram of an example downhole environment having tubulars, in accordance with various aspects of the subject technology.

FIG. 2 illustrates a hydrophone array that is being deployed in a wellbore, in accordance with various aspects of the subject technology.

FIGS. 3A, 3B, and 3C figuratively illustrate examples of how acoustic energy may move within and along a wellbore casing, in accordance with various aspects of the subject technology.

FIG. 4 illustrates impulses of acoustic energy sensed over time at an array of sensors, in accordance with various aspects of the subject technology.

FIG. 5 includes three different images of a hydrophone array that is deployed in a wellbore, in accordance with various aspects of the subject technology.

FIG. 6 illustrates a slowness/frequency amplitude mapping of guided wave modes, in accordance with various aspects of the subject technology.

FIG. 7 illustrates actions that may be performed when a method consistent with a multi-frequency-range and multi-mode guided-wave processing technique is used, in accordance with various aspects of the subject technology.

FIG. 8 illustrates actions that may be performed by a computer model, in accordance with various aspects of the subject technology.

FIG. 9 illustrates a modal analysis map generated based on data collected from multiple different stimulus frequencies used by an acoustic sensing device, in accordance with various aspects of the subject technology.

FIG. 10 illustrates an eccentricity sensitivity map that may have been generated based on the eccentricity sensitivity analysis discussed in respect to FIG. 8, in accordance with various aspects of the subject technology.

FIG. 11 illustrates a channel sensitivity map that may have been generated based on the channel sensitivity analysis discussed in respect to FIG. 8, in accordance with various aspects of the subject technology.

FIG. 12 illustrates a response polarity map that may have been generated based on the channel sensitivity analysis discussed in respect to FIG. 8, in accordance with various aspects of the subject technology.

FIG. 13 illustrates how images generated from data associated with different stimulation frequencies may be combined to generate a final or output cement evaluation image, in accordance with various aspects of the subject technology.

FIG. 14 illustrates an example computing device architecture which can be employed to perform any of the systems and techniques described herein.

### DETAILED DESCRIPTION

Various aspects of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous compounds. In addition, numerous specific details are set forth in order to provide a thorough understanding of the methods and apparatus described herein. However, it will be understood by those of ordinary skill in the art that the methods and apparatus described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the present disclosure.

Systems and techniques of the present disclosure may be directed to evaluating collected data to determine whether or not a wellbore casing has been adequately cemented in place in a wellbore.

Evaluations of cement used to adhere a casing to strata of a wellbore may be performed before a wellbore is placed into service, during the lifespan of the wellbore, or before a wellbore is placed out of service (e.g., during a wellbore is plug and abandonment process). Systems and techniques of the present disclosure may generate mappings from sensed data. Such mappings may map features that correspond the movement of energy through one or more mediums. In some instances, features may be associated with sensed amplitudes, the movement of energy through one or more mediums, or be associated with frequency. As such, mappings discussed herein may include amplitude maps, energy maps, or frequency mappings. These mappings may show relationships associated with velocity (e.g., slowness values) and frequency.

Wellbore cement evaluations assess the quality of bonding between a wellbore casing and cement placed in an area located between a wellbore casing and wellbore strata (a wellbore annulus). In certain instances, production logging requires cement evaluations to be performed when tubing is also deployed in the wellbore. In at least some instances, sensing equipment may be deployed within wellbore tubing. Cracks or voids in cement as well as other defects may allow fluids to flow in ways that can adversely affect operation of the wellbore. For example, a pressure imbalance may cause flows to move through poorly cemented sections along a casing, such flows and/or other leaks can lead to excessive production of unwanted fluids or failure of a wellbore. Because of market demands, there is a great need for the most cost-effective cement bond logging solutions.

When a well approaches the end of its operating life cycle, a plugging and abandonment (P&A) process may be initiated. One possible way to cut the costs during P&A operations is to leave production tubing in the well. By simply abandoning the tubing in the well, companies may save time and costs associated with removing that tubing. In certain municipalities, before a wellbore can be plugged and abandoned, the integrity of the wellbore may have to be evaluated. As such cement bond logging may be required both before a wellbore is placed into service and before that wellbore is plugged and abandoned.

Various efforts of through tubing cement evaluation include using the frequency spectrum of recorded signals, magnetic and/or resonance evaluations, and general borehole sonic dispersion response techniques. These methods provide a free-pipe indicator to reflect the position of free-pipe zones or the top of the cement. However, limited to the omnidirectional monopole transmitter they use, these methods tend to have limited capability in detecting and locating azimuthal bonding information behind the casing.

A hydrophone array may be deployed in a wellbore to collect sounds that may be used to identify whether a wellbore is safe to operate. This hydrophone array may include acoustic sensors (e.g., numerous individual hydrophones) that sense noises of various sorts and a hydrophone array may be referred to as a hydrophone sensing apparatus. For example, a hydrophone sensing apparatus that includes an acoustic transmitter and array of acoustic sensors may emit/transmit pulses of acoustic energy when collecting data that is evaluated to identify how well portions of a wellbore casing are cemented to or otherwise adhered to strata that surrounds the wellbore casing.

When a tool or assembly that includes an array of hydrophones (a hydrophone array) is deployed in a wellbore, acoustic data may be collected. This collected data may include information associated with traveling acoustic waves (the movement of acoustic energy) through specific transmission mediums. One such transmission medium may include a casing that is cemented in place in a wellbore and the acoustic waves that travel through this casing/cement medium may correspond to a first acoustic wave mode or first guided wave mode. Another transmission medium that may be associated with a tube located in the wellbore. As such, acoustic waves that travel along this tube may have characteristics of a second acoustic or guided wave mode.

Methods and systems of the present disclosure may use a multi-frequency-range and multi-mode guided-wave processing technique when determining whether a wellbore is safe to operate or is safe to plug and abandon. Methods of the present disclosure improve upon single frequency approaches that may yield unreliable determinations when eccentricities associated with a sensing assembly being offset from a center line of a casing is greater than a threshold level.

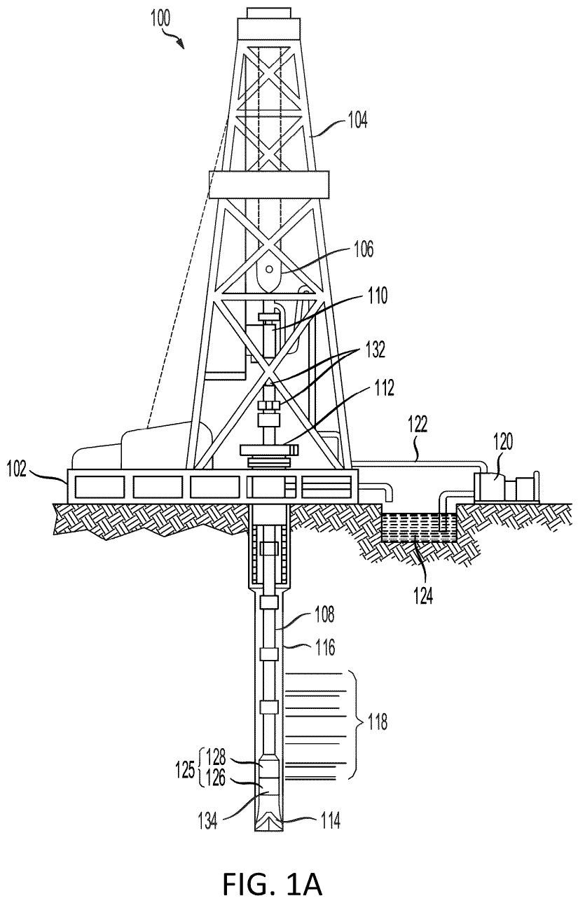

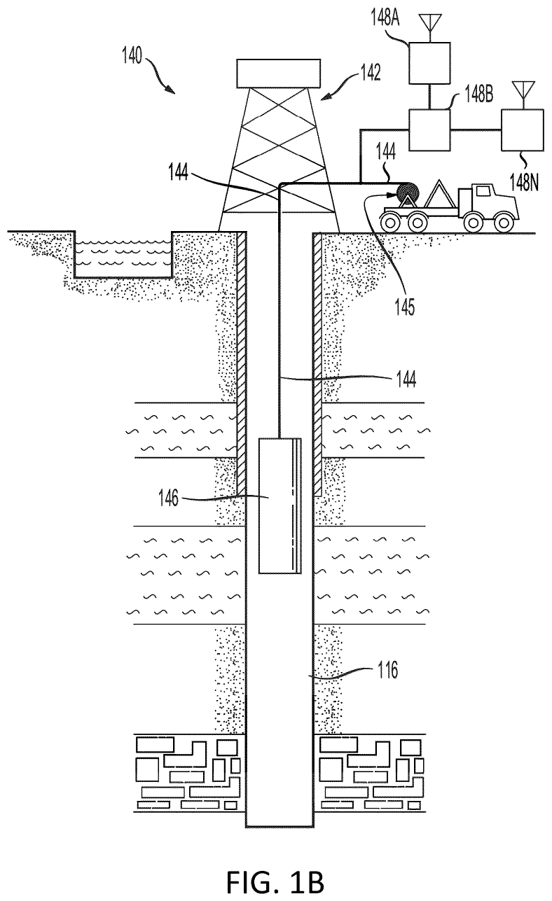

FIG. 1A is a schematic diagram of an example logging while drilling wellbore operating environment, in accordance with various aspects of the subject technology. The drilling arrangement shown in FIG. 1A provides an example of a logging-while-drilling (commonly abbreviated as LWD) configuration in a wellbore drilling scenario 100. The LWD configuration can incorporate sensors (e.g. acoustic sensors, EM sensors, seismic sensors, gravity sensor, sensors, etc.) that can acquire formation data, such as characteristics of the formation, components of the formation, etc. For example, the drilling arrangement shown in FIG. 1A can be used to gather formation data through an tool (not shown) as part of logging the wellbore using the tool. The drilling arrangement of FIG. 1A also exemplifies what is referred to as Measurement While Drilling (commonly abbreviated as MWD) which utilizes sensors to acquire data from which the wellbore's path and position in three-dimensional space can be determined. FIG. 1A shows a drilling platform 102 equipped with a derrick 104 that supports a hoist 106 for raising and lowering a drill string 108. The hoist 106 suspends a top drive 110 suitable for rotating and lowering the drill string 108 through a well head 112. A drill bit 114 can be connected to the lower end of the drill string 108. As the drill bit 114 rotates, it creates a wellbore 116 that passes through various subterranean formations 118. A pump 120 circulates drilling fluid through a supply pipe 122 to top drive 110, down through the interior of drill string 108 and out orifices in drill bit 114 into the wellbore. The drilling fluid returns to the surface via the annulus around drill string 108, and into a retention pit 124. The drilling fluid transports cuttings from the wellbore 116 into the retention pit 124 and the drilling fluid's presence in the annulus aids in maintaining the integrity of the wellbore 116. Various materials can be used for drilling fluid, including oil-based fluids and water-based fluids.

Logging tools 126 can be integrated into the bottom-hole assembly 125 near the drill bit 114. As drill bit 114 extends into the wellbore 116 through the formations 118 and as the drill string 108 is pulled out of the wellbore 116, logging tools 126 collect measurements relating to various formation properties as well as the orientation of the tool and various other drilling conditions. The logging tool 126 can be applicable tools for collecting measurements in a drilling scenario, such as the tools described herein. Each of the logging tools 126 may include one or more tool components spaced apart from each other and communicatively coupled by one or more wires and/or other communication arrangement. The logging tools 126 may also include one or more computing devices communicatively coupled with one or more of the tool components. The one or more computing devices may be configured to control or monitor the performance of the tool, process logging data, and/or carry out one or more aspects of the methods and processes of the present disclosure.

The bottom-hole assembly 125 may also include a telemetry sub 128 to transfer measurement data to a surface receiver 132 and to receive commands from the surface. In at least some cases, the telemetry sub 128 communicates with a surface receiver 132 by wireless signal transmission (e.g., using mud pulse telemetry, EM telemetry, or acoustic telemetry). In other cases, one or more of the logging tools 126 may communicate with a surface receiver 132 by a wire, such as wired drill pipe. In some instances, the telemetry sub 128 does not communicate with the surface, but rather stores logging data for later retrieval at the surface when the logging assembly is recovered. In at least some cases, one or more of the logging tools 126 may receive electrical power from a wire that extends to the surface, including wires extending through a wired drill pipe. In other cases, power is provided from one or more batteries or via power generated downhole.

Collar 134 is a frequent component of drill string 108 and generally resembles a very thick-walled cylindrical pipe, typically with threaded ends and a hollow core for the conveyance of drilling fluid. Multiple collars 134 can be included in drill string 108 and are constructed and intended to be heavy to apply weight on the drill bit 114 to assist the drilling process. Because of the thickness of the collar's wall, pocket-type cutouts or other type recesses can be provided into the collar's wall without negatively impacting the integrity (strength, rigidity and the like) of the collar as a component of the drill string 108.

FIG. 1B is a schematic diagram of an example downhole environment having tubulars, in accordance with various aspects of the subject technology. In this example, an example system 140 is depicted for conducting downhole measurements after at least a portion of a wellbore has been drilled and the drill string removed from the well. A tool (not shown) can be operated in the example system 140 shown in FIG. 1B to log the wellbore. A downhole tool is shown having a tool body 146 in order to carry out logging and/or other operations. For example, instead of using the drill string 108 of FIG. 1A to lower the downhole tool, which can contain sensors and/or other instrumentation for detecting and logging nearby characteristics and conditions of the wellbore 116 and surrounding formations, a wireline conveyance 144 can be used. The tool body 146 can be lowered into the wellbore 116 by wireline conveyance 144. The wireline conveyance 144 can be anchored in the drill rig 142 or by a portable means such as a truck 145. The wireline conveyance 144 can include one or more wires, slicklines, cables, and/or the like, as well as tubular conveyances such as coiled tubing, joint tubing, or other tubulars. The downhole tool can include an applicable tool for collecting measurements in a drilling scenario, such as the tools described herein.

The illustrated wireline conveyance 144 provides power and support for the tool, as well as enabling communication between data processors 148A-N on the surface. In some examples, wireline conveyance 144 can include electrical and/or fiber optic cabling for carrying out communications. The wireline conveyance 144 is sufficiently strong and flexible to tether the tool body 146 through the wellbore 116, while also permitting communication through the wireline conveyance 144 to one or more of the processors 148A-N, which can include local and/or remote processors. The processors 148A-N can be integrated as part of an applicable computing system, such as the computing device architectures described herein. Moreover, power can be supplied via wireline conveyance 144 to meet power requirements of the tool. For slickline or coiled tubing configurations, power can be supplied downhole with a battery or via a downhole generator.

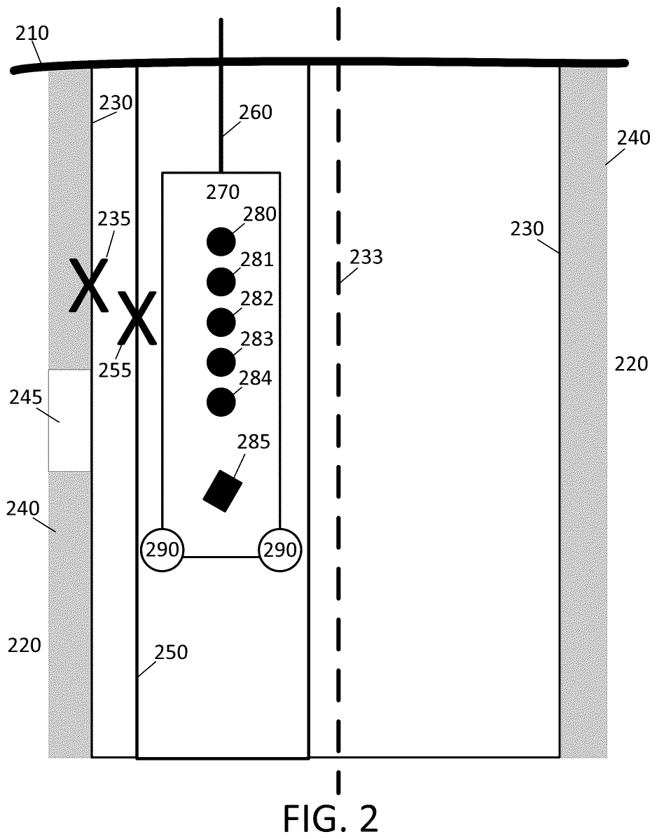

FIG. 2 illustrates a hydrophone array that is being deployed in a wellbore. FIG. 2 includes casing 230 cemented into a wellbore with cement 240, tube 250 that is deployed in casing 230, and hydrophone array 270. Hydrophone array 270 includes a plurality of sensors/microphones (280, 281, 282, 283, and 284), and bumpers 290. Deployment cable 260 may be used to lower hydrophone array 270 into the wellbore casing 230. FIG. 2 also includes ground surface 210 and subterranean strata 220 located below the surface of ground surface 210. While FIG. 2 illustrates hydrophone array 270 being deployed in tube 250, hydrophone array 270 may be deployed within a casing that does not include a tube or may be deployed next to an external surface of a tube that is located within a casing.

The dashed line 233 of FIG. 2 is a center line of casing 230. Note that the hydrophone array 270 and tube 250 are both offset to the left of casing center line 233. Because of this, images generated from raw data collected by hydrophone array 270 will have eccentricities. Evaluations performed on such eccentric data may lead to inaccurate determinations being made in regard to the presence, absence, or size of wellbore defects. Furthermore, the more a hydrophone array is offset from the center line of a casing, the more images generated from collected data may be distorted.

When hydrophone array 270 is lowered into the wellbore casing 230, bumpers 290 may help guide hydrophone array 270 along tube 250. Sounds that travel through a wellbore or wellbore casing 230 travel at a wave propagation speed through one medium or another (e.g., fluids contained within a casing or along walls of the casing). As such, acoustic waves may travel along the walls of tube 250 at the wave propagation speed toward sensors (280, 281, 282, 283, and 284). Sensors 280, 281, 282, 283, and 284 each of these sensors may respectively sense acoustic signals through different paths that are shifted in time. Hydrophone array 270 includes acoustic transmitter 285 that may be used to transmit pulses of acoustic energy when evaluations are performed. For example, when cement bond index (CBI) values of a wellbore are evaluated. In certain instances, multiple frequencies may be transmitted by acoustic transmitter 285. For example, since sensor 284 is closest to transmitter 285 and since each of the other sensors (281, 282, 283, and 284) are located farther from transmitter 285, signals generated by transmitter 285 will be sensed by sensor 284 first and then respectively by sensor 283, 282, 281, and 280. In certain instances, acoustic waves traveling in the walls of a structure (pipes, tube, or casing) may include multiple frequencies, where each frequency may travel at a different wave propagation speed, potentially because of a dispersive nature of the structure. Differences in time that that sound is shifted may vary based on the wave propagation speed in mediums that the sound travels through. When sensors 283, 282, 281, and 280 are separated by a specific distance, the times that specific wave signals reach specific sensors may be used to identify a velocity of particular sound signals.

Sound traveling from a sound source along the tube or other structure (e.g., casing 230) may travel within the wall of the tube 250 or other structure, may travel in a fluid medium adjacent to the tube or other structure (e.g., casing 230), or may travel through both. When the hydrophone array is deployed in a wellbore, sounds sensed by sensors of the hydrophone array may be used to detect sounds that are associated with a wellbore defect. A defect (e.g., a crack) in a tube 250 (e.g., defect 255), a crack a casing 230 (e.g., defect 235), or a channel in cement 240 (e.g., channel 245) of the wellbore may generate sounds as fluids leak or move through such defects. FIG. 2 includes two different defects, identified with X marks, a first defect 235 may be a crack in cement 240 and in casing 230, and a second defect 255 may be a crack in tube 250. FIG. 2 also includes channel 245 created by defective cement. Channel 245 may be an area where cement is missing or has separated from or is not well bonded to casing 230. Sensors 280, 281, 282, 283, and 284 of hydrophone array 270 may sense sounds transmitted by one or more acoustic transmitters (e.g., transmitter 285) when those transmitters emit pules of different frequencies.

Transmitter 285 and sensors 280, 281, 282, 283, and 284 of hydrophone array 270 may each be unipolar transmitters or receives. In certain instances, unipolar transmitters and receivers may be aligned to a same azimuth around the body of hydrophone array 270. Note that sensors 280, 281, 282, 283, and 284 may be rotated to face different azimuths so that waveform responses may be collected from a plurality of different angles. In such instances, transmitter 285 may emit sonic signals, which impact casing 230 and generate guided waves propagating mainly along casing 230. The receiver array (sensors 280, 281, 282, 283, and 284) may sense these signals and these signals may be recorded as a time series set of waveforms. Evaluations may then be performed on data associated with the set of waveforms. In certain instances, recorded waveforms may include data from different types of modes. Each of the different modes may be associated with sounds traveling along different pathways. Some modes may be associated with sounds moving through a formation surrounding the wellbore, be associated with the movement of fluids, be associated with sound moving through different respective structural elements of the wellbore (e.g., along a wellbore casing or wellbore tube). Sound waves traveling along a casing may be referred to as casing-guided waves and sounds traveling along a set of tubing may be referred to as tubing-guided waves. In certain instances, these modes may be sensitive to bonding conditions. Depending on constraints of a particular implementation, transmitter 285 may be a monopole, dipole, or quadrupole transmitter. Similarly, receivers or sensors 280, 281, 282, 283, and 284 may be configured in a monopole, dipole, or quadrupole receiver configuration.

Sounds traveling from a bottom portion of hydrophone array 270 will travel upward toward the array of sensors (280, 281, 282, 283, and 284) of hydrophone array 270 at the wave propagation speed. This means that each of the sensors (280, 281, 282, 283, and 284) will sense particular sounds at different times and that signals generated by receipt of these sounds by the sensors will be offset in time. The timing offsets are a function of the wave propagation speed. To some extent, the same may be true for sounds generated by leaks in a tube or other wellbore structure. Since defect 255 is located near a center portion of the array of hydrophone sensors (280, 281, 282, 283, and 284), sounds associated with such leaks will not be offset in the same direction as sounds that propagate from one end of hydrophone array 270 to another end hydrophone array 270. Since defect 255 is located in the middle of the sensor array, sound generated by fluids leaking through defect 255 will first be received by sensor 282, after which sensors 281 and 283 will receive the leaking sound, and then the leaking sound will be received by sensors 280 and 284. As such, some sound energy from defect 255 travels upward and some sound energy from defect 255 travels downward.

Based on the position of defect 235 relative to the location of hydrophone array 270, leaking sounds received by the sensors of the hydrophone array will be received in the following order: first sensor 281 will receive the leaking sound, then sensors 280 and 282 will receive the leaking sound, next sensor 283 will receive the leaking sound, and then sensor 284 will receive the leaking sound.

This means that some sounds received by the sensors (280, 281, 282, 283, and 284) may always be shifted in time in the same direction while some sounds may travel in opposite directions. Sounds from other sources may be received by hydrophone array 270, and each of these other sounds may be received at respective sensors of hydrophone array 270 based on mediums that the sounds traveled through.

Hydrophone array 270 may include one or more acoustic transmitters 285 that transmit acoustic energy as well as a plurality of sensors (e.g., sensors 280-284) that sense acoustic energy (sonic or ultrasonic). In certain instances, an acoustic energy transmitter may be directional or steerable. In other instances, an acoustic energy transmitter may not be directional or steerable. When a cement bonding verification process is performed, pulses of acoustic energy may be transmitted from transmitter 285 of hydrophone array 270. In certain instances, respective pulses or pulse sequence transmitted by transmitter 285 may have different frequencies. Once such pulses are transmitted, a portion of the energy of these pulses may travel along casing 230 in the form of acoustic sounds. Each of sensors 280-284 may sense the sound as it travels along casing 230 when acoustic data is collected. Evaluations may be performed on this collected data when CBI values of the wellbore are identified. These CBI values may be used to determine whether or not a wellbore casing is properly cemented into a wellbore. Acoustic energy may travel from the transmitter to the receiver via several different paths and each of these paths may be referred to as a specific mode. Even inside the wall of a casing, there may be different modes of energy movement, in such an instance, each mode may have a different frequency and velocity. When a dataset that includes multiple modes associated with a wellbore casing, each of these different modes may be separated when analysis consistent with the present disclosure is performed.

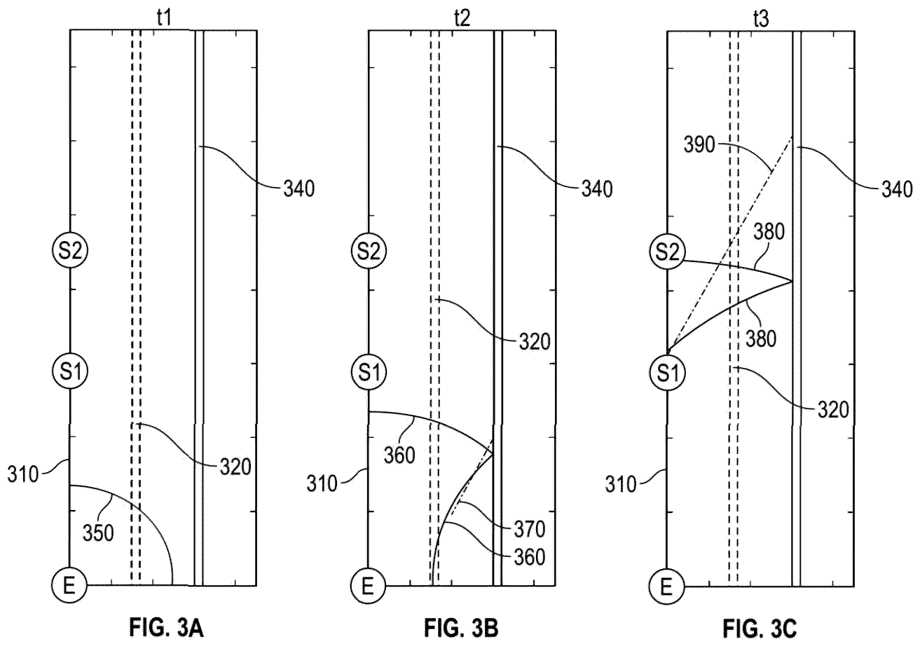

FIGS. 3A, 3B, and 3C illustrate a semi-cross-sectional view of an exemplary wellbore where a hydrophone array is deployed. Each of FIGS. 3A, 3B, and 3C include acoustic transmitter E and sensors S1 & S2 of hydrophone array 310. Each of FIGS. 3A, 3B, and 3C also include tube 320 and casing 340 that is cemented in place in a wellbore. Note that in this instance, hydrophone array 310 is deployed within casing 340 next to tube 320. FIGS. 3A, 3B, and 3C show propagation of transmitted acoustic energy and “guided wave” signals associated with the transmitted acoustic energy at respective times t1, t2, and t3. For example, time t1 may correspond to 0.083 milliseconds (ms), time t2 may correspond to 0.15 ms, and time t3 may correspond to 0.286 ms after an acoustic pulse was transmitted.

FIGS. 3A, 3B, and 3C figuratively illustrate examples of how acoustic energy may move within and along a wellbore casing. FIG. 3A shows acoustic energy 350 propagating away from transmitter E at time t1 after a pulse of acoustic energy was transmitted from transmitter E. As the transmitted acoustic energy propagates toward tube 320 and casing 340, that energy will impact an internal wall of the casing generating guided wave signals that propagate along the casing. To reach sensors of a hydrophone assembly, portions of the acoustic energy that travels along the casing as guided waves exits or escapes the casing as those guided waves move along the casing. Because of this, casing related guided waves that are sensed by the sensors of the hydrophone may be referred to as “leaky-guided waves.” FIG. 3B shows acoustic energy 360 and leaky-guided wave signal 370 at a time t2 after the pulse was transmitted from transmitter E. Similarly, FIG. 3C shows acoustic energy 380 and leaky-guided wave signal 390 at a time of t3 after the pulse was transmitted from transmitter E. As such, FIGS. 3A, 3B, and 3C show that sounds associated with the transmitted pulse and sounds associated with guided waves induced in casing 340 are sensed by sensors S1 & S2. Since energy of the transmitted acoustic pulse and the guided waves move through different mediums, energy of the transmitted acoustic pulses and the leaky-guided waves will be sensed at sensors S1 & S2 within relative timing that corresponds to at least two different transmission modes. This also means that sound waves of the transmitted acoustic pulse will tend to have a different velocity than the guided waves that travel along casing 340. While FIGS. 3A-3C show leaky-guided wave signals 370 and 390, these wave signals do not necessarily correspond to all wave modes that casing 340 may have. As such FIGS. 3A-3C do not show all of the leaky-guided wave modes that may be sensed by sensors S1 & S2.

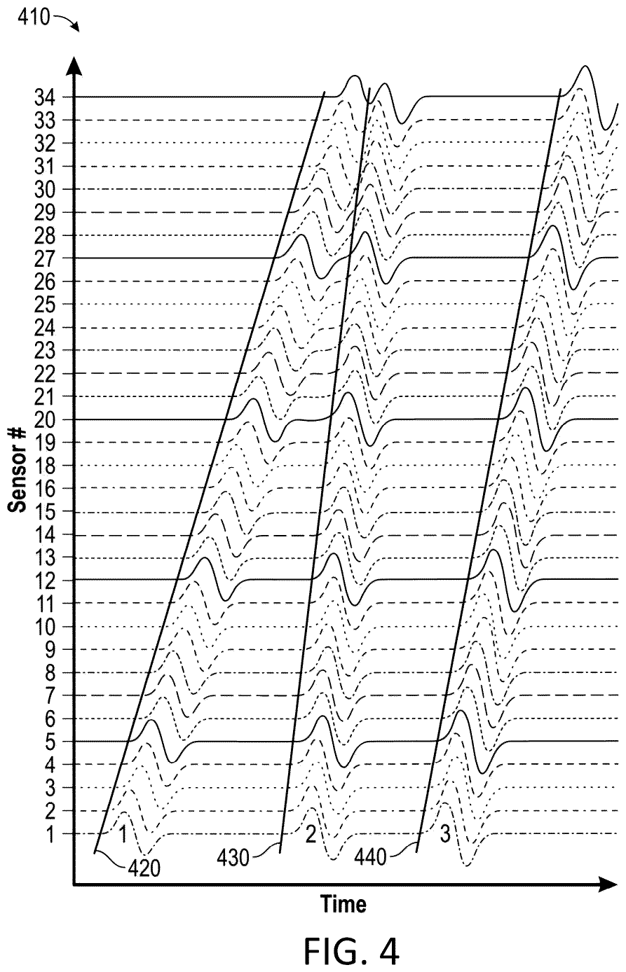

FIG. 4 illustrates impulses of acoustic energy sensed over time at an array of sensors. FIG. 4 shows energy sensed by respective sensors (sensor 1 through sensor 34) over time in image 410. As such FIG. 4 includes a vertical axis that shows changes in amplitudes received at each sensor of a hydrophone. FIG. 4 also includes a horizontal axis of time. Since each respective sensor of the hydrophone may be separated from a next sensor of the hydrophone by a separation distance D, velocities or other values of propagation may correspond to how a wave of a particular energy pulse is received respective sensors. An example of other propagation values may be termed “slowness values,” and respective slowness values may be proportional to the inverse of specific velocity values. As such, slowness value SL1 may equal X times the inverse of velocity value 1 (V1), or SL1=X (1/V1), where X is a proportionality value or constant.

Each respective sensor (sensors 1-34) senses what may appear to be three groupings of pulses. Numbers 1, 2, and 3 that appear next to lines 420, 430, and 440 represent that there are three different acoustic wave modes included in FIG. 4. FIG. 4 illustrates acoustic energy sensed by respective sensors at different times and energy associated with more than one of these three acoustic wave modes may be associated with transmission of signals along a same medium (e.g., along the medium of a wellbore tube). Since theses sensors are separated by the same distance, a velocity that these pulses travel correspond to the separation distance D divided by a difference in the amount of time separating the moment in time that a pulse was sensed by one sensor (e.g., sensor number 1) and a next sensor (e.g., sensor number 2). Lines 420, 430, and 440 correspond to velocities that each respective pulse was sensed at each respective sensor. Since each of the slopes of lines 420, 430, and 440 are different slope, each of the pulses (pulses number 1, 2, and 3) travel between different sensors at different velocities. Each of these different pluses may have been generated by the same noise source (e.g., transmitter 285) and then traveled through a different medium (e.g., along a wellbore casing or a set of wellbore tubing) before reaching a particular sensor. Like above, each of these velocities may have a slowness value that corresponds directly to a velocity or be inversely proportional to a velocity.

Since the velocity that sound travels through different mediums varies and since the slopes of lines 420, 430, and 440 each correspond to a different velocity, in an instance when acoustic energy is used to excite a resonance in a wellbore casing, one set of acoustic waves received by sensors of a hydrophone should correspond to acoustic energy traveling along the wellbore casing (a first acoustic or specific “guided wave mode”). In FIG. 4, the pulses along line 430 correspond to acoustic waves traveling according to an acoustic wave mode (or “guided wave mode”) of the casing. Of the various pulses of acoustic energy sensed by sensors 1-34, only the acoustic pulses associated with the guided wave mode of the casing (e.g., slope of line 430) should be evaluated when making determinations regarding how well the casing is cemented to strata that surrounds a wellbore. As such, only data that corresponds to acoustic pulses of line 430 should be analyzed when CBI values are assigned to the wellbore.

The process of assigning CBI values to a wellbore may include collecting data along a wellbore. This may include transmitting acoustic pulses from a hydrophone array, collecting sensed data, moving the hydrophone array, and repeating this process along the wellbore. This movement of the hydrophone array may include rotating the hydrophone array and/or moving the hydrophone array along the wellbore (e.g., up or down). Evaluations may be performed from the collected data when CBI values are assigned to respective portions of the wellbore. Such evaluations may be performed as the data is collected or may be performed after the data has been collected. Once identified, respective CBI values as well as other data may be stored in a CBI log. Further evaluations may be performed to identify whether these CBI values correspond to a casing that can be placed into operation. As such, the evaluations discussed in this disclosure may be required before a wellbore can be put into service. In instances when certain locations of the wellbore are determined to appear to have poor adhesion, a repair operation may be initiated. Alternatively, a determination may be made (based on a criteria) that the location where the apparent poor adhesion is located is acceptable. Bonding evaluations may also be performed at the end of the life of a wellbore to make sure that a plug and abandonment process can be completed safely based on an end-of-life cycle criterion. Such a plug and abandonment process may evaluate cement bond logs to identify areas of the wellbore that should be plugged to isolate respective zones of the wellbore to prevent fluids from moving from one zone (e.g., depth) of the wellbore to another zone of the wellbore. An end-of-life criterion may require that cement bond logs be collected and data from those logs should be evaluated to identify locations of the wellbore where plugs (e.g., cement plugs) should be placed to prevent flids from one zone of the wellbore moving to another. For example, areas of the wellbore that have lower CBI values (e.g., less than decommission CBI a threshold value) may be isolated from areas of the wellbore that have higher cement bond index values (e.g., higher than the decommission CBI value). Additionally, or alternatively areas of the wellbore that are near strata where water is located may be isolated from areas of the wellbore that are near strata where oil is located by plugging the wellbore at specific depths.

When a repair is determined to be required, a hole may be drilled in the casing and cement may be forced through that hole to fix an apparent cement bond defect. Criteria for determining whether a wellbore is fit for service may include identifying that all CBI values of the wellbore at least meet a threshold level or may identify that areas where a CBI value does not meet that threshold corresponds to a void or defect size that is below a defect threshold size. This may be because small defects or voids in cement are known to have a low probability of adversely affecting the operation of the wellbore during its lifespan.

Once energy associated with the acoustic wave mode (guided wave mode) of the casing is identified, the data collected by operation of the hydrophone array may be filtered by removing data associated with other wave modes (e.g., wave modes associated with lines 420 and 440). Alternatively, data associated with line 430 (the acoustic wave mode of the casing) may be extracted from the collected data.

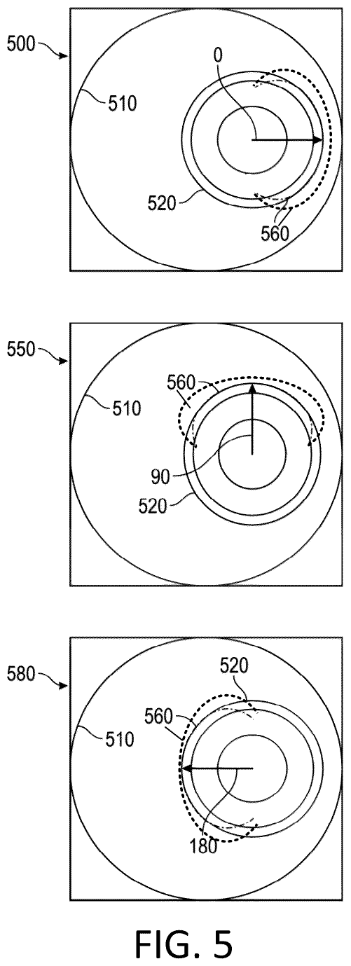

FIG. 5 includes three different images of a hydrophone array that is deployed in a wellbore. These three different images (500, 550, and 580) depict cross-sectional images of a wellbore casing 510 and tube 520 within which a hydrophone array is deployed. Images 500, 550, and 580 are each made from a perspective that looks down wellbore casing 510. The images of FIG. 5 show that a hydrophone array may be deployed in tube of a wellbore. Note that tube 520 is not located at the center point of wellbore casing 510. Note that the hydrophone array of FIG. 5 is not located at the center point of wellbore casing 510 as the location of hydrophone array is centered within tube 520.

In image 500, the hydrophone array is pointed in a direction that corresponds to 0 degrees (toward the right of FIG. 5), at this time hydrophone array emits acoustic energy 560. In image 550, the hydrophone array is pointed in a direction that corresponds to 90 degrees (toward the upper portion of FIG. 5), at this time hydrophone array emits acoustic energy 560. In image 580, the hydrophone array is pointed in a direction of 180 degrees (toward the left of FIG. 5), at this time hydrophone array emits acoustic energy 560. As a hydrophone array spins in tube 520, it emits pulses of acoustic energy and senses acoustic energy that may be associated with guided wave modes of tube 520 and casing 510, for example.

In instances when a single frequency is used to collect acoustic data, actions performed to process such data may be referred to as single-frequency-range guided wave processing. While such a single frequency approach may yield reliable determinations, determinations from such a single frequency approach may not always be reliable, for example, in instances when eccentricities associated with a sensing assembly being offset from a center line of a casing by greater than a threshold level. Such offsets that meet or exceed this threshold level may be referred to as having a high eccentricity.

Waveform data received by a hydrophone array may be processed. Since this waveform data is acquired by sampling data received by sensors that are separated by known distances (spaces), these waveform data are in the spatiotemporal domain. This data may be converted to the slowness-frequency or frequency-wavenumber domain by performing a transformation. For example, a two-dimensional (2D) Fourier transform may be used to transform the data into the frequency (FK) domain. Alternatively, or additionally, a one-dimensional (1D) Fourier transform, and a frequency domain beamforming approach may be used. As discussed above, FIG. 4 shows raw waveforms captured by the hydrophone receiver array. From this data, amplitude mappings may be generated that plot slowness values versus frequency. Such a plot may identify higher amplitudes of sensed sound using lighter colors and lower amplitudes of sensed sound using darker colors.

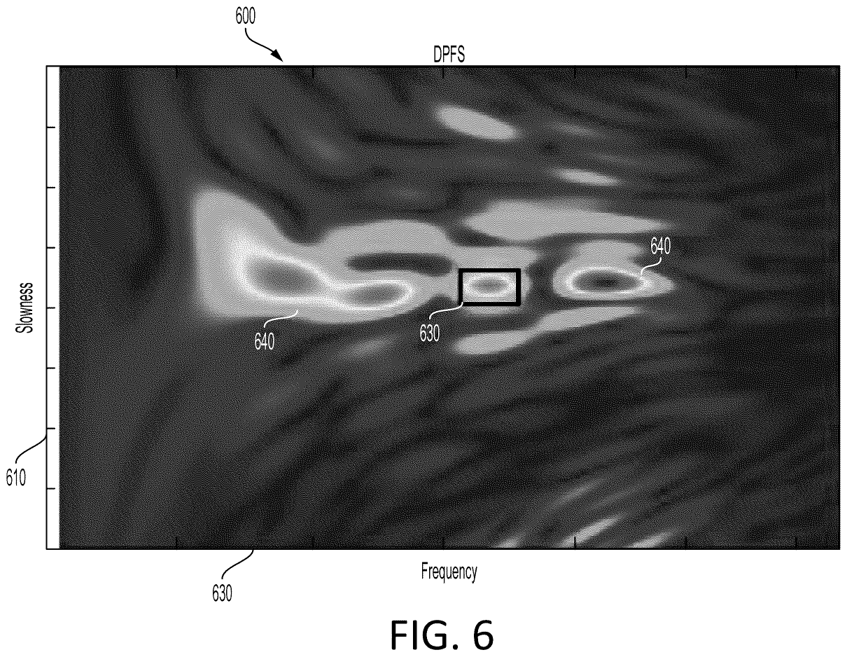

FIG. 6 illustrates a slowness/frequency amplitude mapping of guided wave modes. The mapping 600 of FIG. 6 includes a vertical axis 610 of slowness and a horizontal axis 620 of frequency. In certain instances, slowness/frequency amplitude mappings may be in the form of a color image. Colors in such an image may be similar to colors in a heat map where colder areas correspond to slowness values and frequencies that have low acoustic amplitudes and warmer areas correspond to slowness values and frequencies that have higher acoustic amplitudes. Such a color scale mapping may use dark blue to represent areas with little or no acoustic energy, light blue may have some acoustic energy, yellow or orange may have a medium level of acoustic energy, and red may have a high level of acoustic energy. In a grayscale image depicting the same mapping, particular shades of gray may correspond to the colors mentioned above. Note that mapping 600 includes several areas 630, 640, & 650 in the center of the mapping that are associated with higher levels of acoustic energy.

While these transformations and mapping processes are performed or after these transformations and mapping processes are performed, a modal analysis may be performed. Such actions may be performed in either a serial or parallel based on an architecture of a computer that performs the transformations, mappings, and/or modal analysis. For example, a multiprocessor system may be used where a first set of one or more processors perform transformations and/or mappings and another set of one or more processors perform the modal analysis. This modal analysis may use information that identifies data specific to a particular wellbore environment. For example, this information may identify dimensions of a wellbore casing and/or dimensions of tubing used in the wellbore environment.

The modal analysis may identify dispersion and sensitivity data associated with a particular guided wave mode (a targeted guided wave mode). Based on the modal analysis results, a slowness-frequency window may be selected to ensure that the modal is sensitive to the bonding condition and the sensitivity is consistent in the selected window.

Based on the modal analysis, there may be a few sets of sonic modes that may be focused on. For example, these modes may include a propagating fluid mode, a casing-guided wave mode, and/or a tubing-guided mode. In certain instances, analysis may focus on the casing-guided wave mode. Such analysis may provide both good axial and azimuthal response for materials behind the casing. The other modes, for example, the fluid mode, may also contain bonding information but with less azimuthal resolution.

Different acoustic wave modes may each be plotted in a graph that plots slowness versus frequency as discussed in respect to FIG. 6. Such a graph may include plots of a casing guided wave mode and a tubing guided wave mode. In certain instances, a rectangular window is selected on the casing-guided wave dispersion based on the property of the mode and also the directivity of sensors. The window identified by area 630 may correspond to a target wave mode of interest. For example, the wave mode that corresponds to a wellbore casing. This selected slowness-frequency window (e.g. window of area 630) may be applied to the data of a slowness/frequency graph. A feature in the slowness-frequency window of a target mode (e.g., the casing guided wave mode) will be extracted. For example, the amplitude of the target mode may be extracted by taking root-mean-square values of the data in the selected window. The above processing may be repeated for different depths and azimuths, and a matrix of modal feature of depths and azimuths may be calculated. A raw amplitude mapping may then be generated.

Next, an eccentricity calibration procedure may be performed. A library with eccentricity gain factors, may be identified from field data or modeling data, and these gain factors may be applied to the raw amplitude map. After calibration, a calibrated amplitude map may be generated and this calibrated amplitude may suppress effects inherently generated by an off center or eccentric location of an tool. An eccentricity gain factor for a tubing eccentricity of 35%, for example, may be used to generate more accurate mappings of wellbore cement characteristics (e.g., well adhered cement, the presences of a crack, or the presence of a channel next to a wellbore casing) despite the eccentricity.

Discussion will now move toward multi-frequency-range and multi-mode guided-wave processing techniques of the present disclosure. As mentioned above, a single frequency approach may yield unreliable determinations when eccentricities associated with a sensing assembly being offset from a center line of a casing is greater than a threshold level. As mentioned above, such offsets that meet or exceed this threshold level may be referred to as having a high eccentricity.

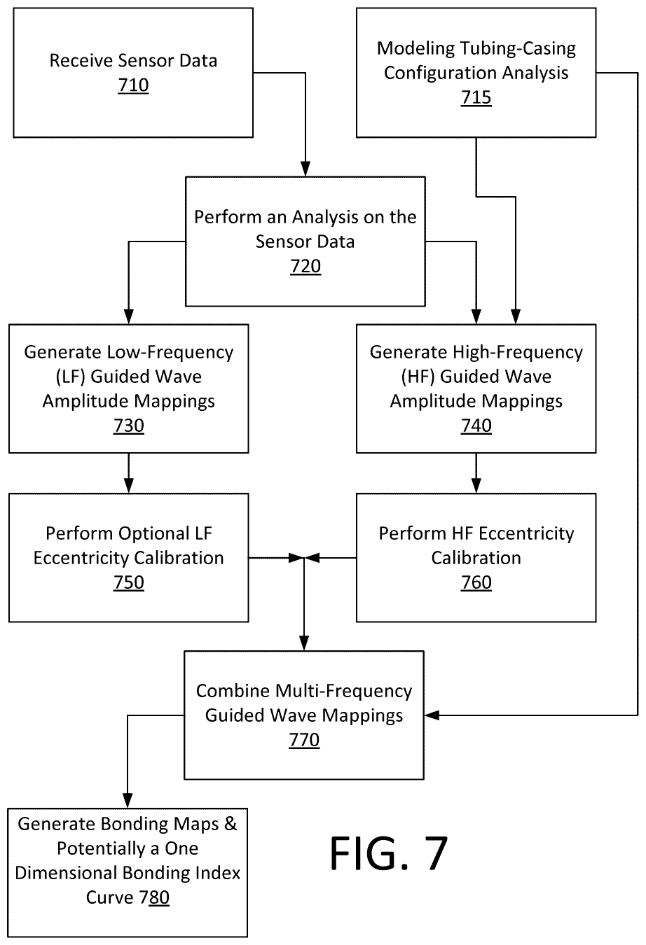

FIG. 7 illustrates actions that may be performed when a method consistent with a multi-frequency-range and multi-mode guided-wave processing technique is used. In other words, FIG. 7 shows the workflow of multi-frequency-band and multimode processing. The process may include emitting (transmitting) signals from a hydrophone array and collecting data from sensor of the hydrophone array. Different frequencies of acoustic (sonic and/or ultrasonic) energy may be emitted by a transmitter and sounds associated with one or more different acoustic wave modes may be sensed by the sensors of the hydrophone array. Energy sensed by each of the sensors may be sampled with an analog to digital converter (ADC) at a sufficient sample rate such that data output from the ADC describes content of acoustic waveforms sensed by each of the sensors. At block 710, the data sensed by the sensors may be received or accessed. While the workflow of FIG. 7 may have some similarities to single frequency approach discussed above, the workflow of FIG. 7 may use more than one slowness-frequency windows.

At block 720 an analysis may be performed on this sensed data. This may include analyzing attributes of different waveforms described by the sensed data. Methods used to perform this analysis may be a “differential-phase frequency semblance” (DPFS) analysis. The analysis performed at block 720 may be performed based on one or more processors executing instructions out of a memory when those processors implement a digitally sampled processing and analysis system directed to fundamentally improving the safe operation, management, and lifecycle of wellbores. As such, systems and techniques of the present disclosure fundamentally improve operation of a technological device.

The multi-frequency-range method may select more than one slowness-frequency window in a slowness-frequency map. As such, the analysis at block 720 may separate data associated with one or more relatively lower frequencies and data associated with one or more relatively higher frequencies from the data received at block 710. The one or more relatively lower frequencies may correspond to a first range of frequencies or a maximum frequency threshold value (e.g., a first set of frequencies). Similarly, one or more higher frequencies may correspond to a second range of frequencies or a minimum frequency threshold (e.g., a second set of frequencies). In some instances, received data may be separated based on more than two frequency ranges or sets of threshold frequency limit values.

Respectively at blocks 730 and 740 amplitude mappings of guided wave modes may be generated. The amplitude mappings generated at blocks 730 and 740 may appear like the amplitude mapping of FIG. 6. These amplitude mappings may be generated independently, for example, one for the set of lower frequencies and another for the set of higher frequencies.

Here again, windows may be selected in a mapping and each of these mapping may correspond to a particular guided wave mode. These windows may include different modes or different portions of specific modes. Windows may be selected by identifying areas in one or more mappings that show different responses to bonding conditions, effects of eccentricity, and/or effects associated with a subterranean formation near the wellbore.

The slowness windows may be separated into two groups or more groups. For example, when two groups are used a first group may correspond to a low-frequency range and a second group may correspond to a high-frequency range. Note that these two groups may have totally different response and control factors. The modeling-based data analysis engine may be configured to support the selection and optimization of the slowness windows. Each slowness-frequency window may be processed separately to create an amplitude map. Overall, windows that are sensitive to channel and less sensitive to eccentricity and formation effects may be selected. Further, the eccentricity and formation effects may be suppressed by combining maps from multiple different windows.

In certain instances, after the guided wave amplitude mappings have been generated and potentially after windows have been selected or otherwise identified in those mappings, one or more eccentricity calibration functions may be performed. This may include performing an optional low frequency eccentricity calibration function at block 750 and/or performing a high frequency eccentricity calibration function at block 760 of FIG. 7. These calibrations may remove distortion that was present in the sensor data received at block 710. For example, distortions caused by the placement of a hydrophone assembly being offset from a casing center line (eccentricity distortions) may be compensated for or corrected. At block 770, mappings made from the compensated/corrected data may be combined.

Block 715 represents a modeling process that may use tubing and/or casing configuration information to perform an analysis. An output of this analysis may be proved to processes that generate the wave amplitude mapping of block 740. Another output of the analysis performed at block 715 may be provided to block 770 of FIG. 7 such that the combined guided wave mapping may be generated based on the known configurations of tubing and/or casing. This may be based on the logic created by the modeling-based data analysis results. At block 780, a final bonding map and potentially a 1D/other bonding index curve may be generated based on the combined guided wave map.

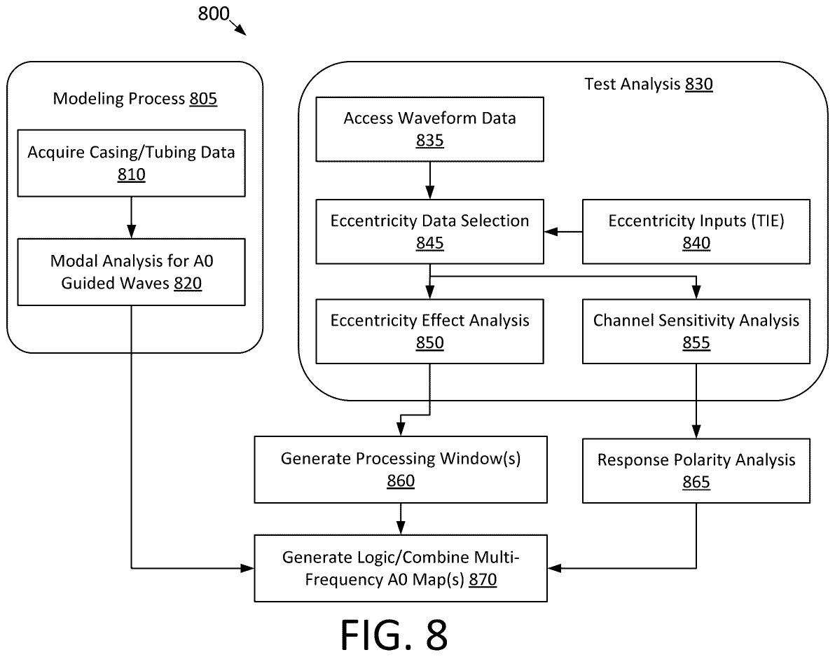

FIG. 8 illustrates actions that may be performed by a computer model. The workflow of FIG. 8 may be described as a modeling-based data analysis engine 800. This may include performing a joint analysis of modelling data and the measured field data for a specific configuration of casing and/or tubing configuration. One or more of the actions of FIG. 8 may be performed at block 715 of FIG. 7.

The modeling-based data analysis engine 800 includes a modeling process 805 of actions and a test analysis process 830 group of actions. The modeling process 805 may acquire/access data that identifies information about a specific wellbore. This information may identify a diameter of a casing, the thickness of the casing, a diameter of a set of tubing, and a thickness of that set of tubing. A set of casing and/or tubing information of a specific wellbore may be referred to as a casing and tubing configuration of that specific wellbore. Modeling process 805 of FIG. 8 may acquire this casing and tubing information at block 810 such that a modal analysis regarding guided wave modes may be performed at block 820 of FIG. 8.

Analysis performed by modeling process 805 at block 810 and block 820 may identify various factors that may be characteristic of a wellbore. This analysis may forecast details regarding modal dispersion of acoustic waves, may predict excitation intensities of specific modes at various frequencies, and may perform modeling to identify how sensitive a tubing-casing configuration should be to different excitation frequencies.

The test analysis process 830 may access or otherwise receive waveform data at block 835. At block 845 portions of the accessed data may be selected based on eccentricity. These selections may be affected by eccentricity input information received from block 840. The eccentricity input information may have been identified based on an analysis of third interface echo (TIE) information. This TIE information may be identified based on an analysis of echo data. Data with strong eccentricity may be collected for an eccentricity sensitivity (or effect analysis) and data with now or little (below a threshold level of) eccentricity may be used to channel sensitivity and a reverse polarity analysis.

At block 850 an analysis may be performed that identifies how the data with higher eccentricities affects the data accessed at block 835. The analysis performed at block 850 may be referred to as an eccentricity effect analysis or an eccentricity sensitivity analysis. For example, in an eccentricity sensitivity analysis, data with a specific high level of eccentricity are collected. For example, data that has an at least 70% measure of eccentricity. These data will be aligned first to ensure all data have a reference tubing eccentricity angle of 0-degrees. That data may then be converted to a slowness-frequency domain with a transform algorithm. For example, frequency-domain beamforming may be used to transform this data. Then, for a specific slowness frequency, median values via depth at each azimuth may be identified. From this, eccentricity gain factors for this slowness-frequency pair may be identified. Next, a Fourier Transform may be performed on the eccentricity gain factors: When A(n)=FT(ECC(θ)), eccentricity sensitivity factors sens_{ecc} may be calculated using the formula

$${sens}_{ecc} = {\sum }_{m = 1}^{m = \frac{n}{2}} A ( m ) / A ( 0 ) .$$

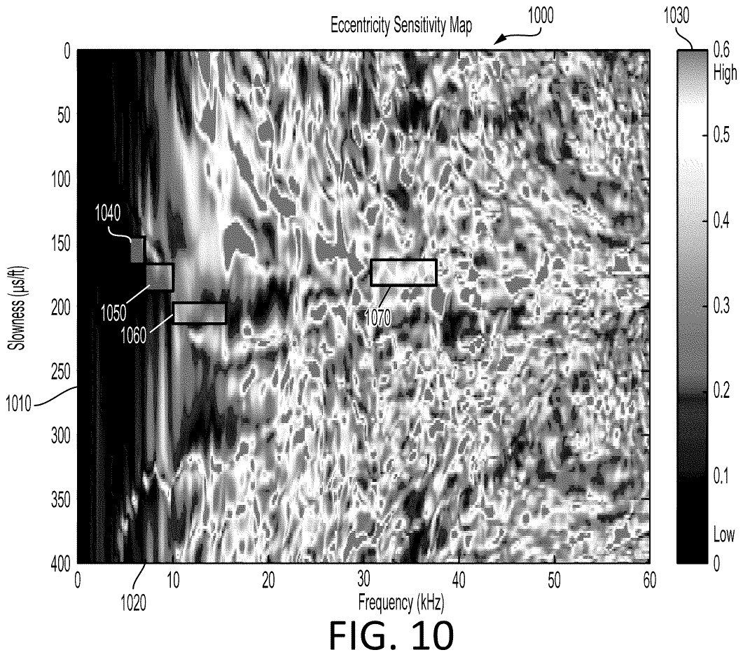

The above processing may be applied to different slowness-frequency pairs, and this process may output an eccentricity sensitivity map shown in FIG. 10.

At block 855 an analysis may be performed that identifies how the data with lower eccentricities will likely affect a channel sensitivity analysis at block 855. In the channel sensitivity analysis, data used in the sensitivity analysis may have been selected based on having values with relatively lower values of eccentricity. For example, eccentricity data associated with a set of tubing that has less than a threshold level of electricity may be selected. The waveform data may be converted in the slowness-frequency domain by a processing method, such as a frequency-domain beamforming method. One or more reference slowness-frequency windows may then be identified. Calculations may be performed to identify a reference response of the target signals versus acquisition from data of the identified slowness-frequency window. This reference response may serve as a baseline for comparison. For example, for a specific slowness-frequency pair, we obtain resp (s, f, acq), and calculations may be performed at block 855 to identify the semblance of the repose with a reference response, named positive sensitivity using Equation 1:

$${Sens}_{channel}^{+} ( s , f ) = \frac{\vert {\sum }_{acq = 1}^{acq = m} resp ( s , f , acq ) + {resp}_{ref} ( s , f , acq ) \vert}{{\sum }_{acq = 1}^{acq = m} \vert resp ( s , f , acq ) \vert + \vert {resp}_{ref} ( s , f , acq ) \vert} \qquad Equation 1$$

Alternatively, or additionally, calculations may be performed at block 855 to identify the semblance of the repose with a negative reference response (e.g., a negative sensitivity) using Equation 2:

$${Sens}_{channel}^{-} ( s , f ) = \frac{\vert {\sum }_{acq = 1}^{acq = m} resp ( s , f , acq ) - {resp}_{ref} ( s , f , acq ) \vert}{{\sum }_{acq = 1}^{acq = m} \vert resp ( s , f , acq ) \vert + \vert {resp}_{ref} ( s , f , acq ) \vert} \qquad Equation 2$$

A final channel sensitivity may be identified based on Equation 3:

$${Sens}_{channel} ( s , f ) = \{ \begin{matrix}{Sens}_{channel}^{+} ( s , f ) & if {Sens}_{channel}^{+} ( s , f ) \geq {Sens}_{channel}^{-} ( s , f ) \\ {Sens}_{channel}^{-} ( s , f ) & if {Sens}_{channel}^{+} ( s , f ) < {Sens}_{channel}^{-} ( s , f )\end{matrix} \qquad Equation 3$$

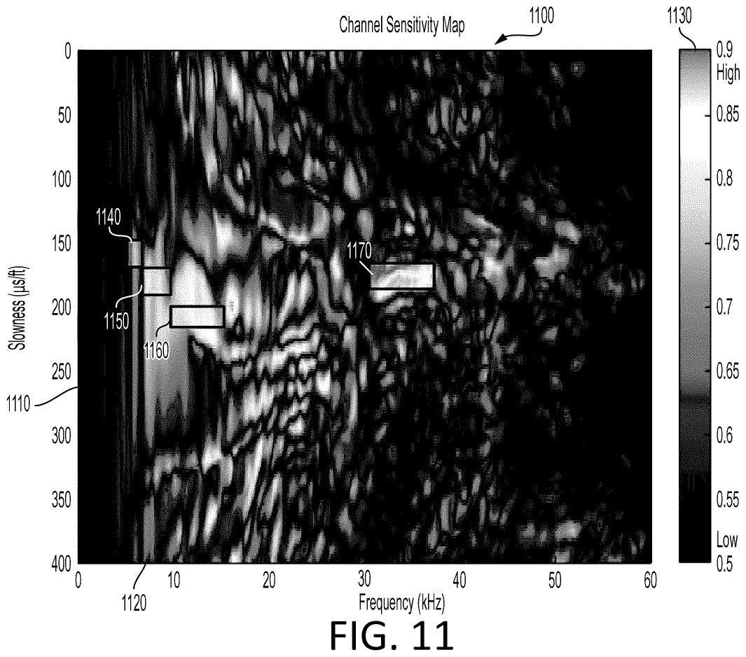

Note that the channel sensitivity map of FIG. 11 may show whether the data at the slowness-frequency pair of (s, f) is sensitive to the bonding condition.

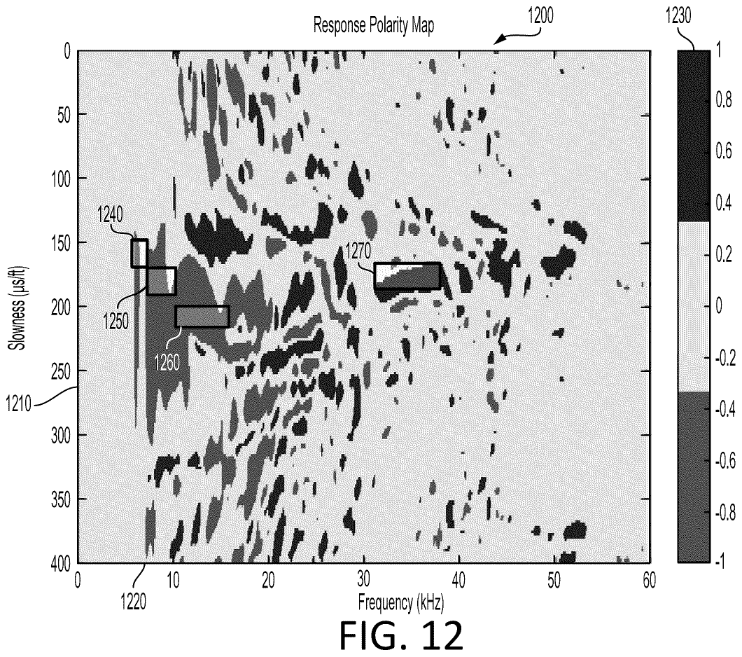

At block 865, a response polarity analysis may generate the response polarity analysis map of FIG. 12. This polarity map may be generated at block 865 using Equation 4:

$${p}_{channel} ( s , f ) = \{ \begin{matrix}1 & if {Sens}_{channel}^{+} ( s , f ) \geq {Sens}_{channel}^{-} ( s , f ) \\ - 1 & if {Sens}_{channel}^{+} ( s , f ) < {Sens}_{channel}^{-} ( s , f )\end{matrix} \qquad Equation 4$$

At this time, the polarity map may show that the data is positively or negatively coherent to the reference map. In addition, a map may be selected based on a determination regarding which map of a plurality of maps better reflects channel sensitivity. This selection may be made based on a criterion, on machine learning, or operation of an artificial intelligent system.

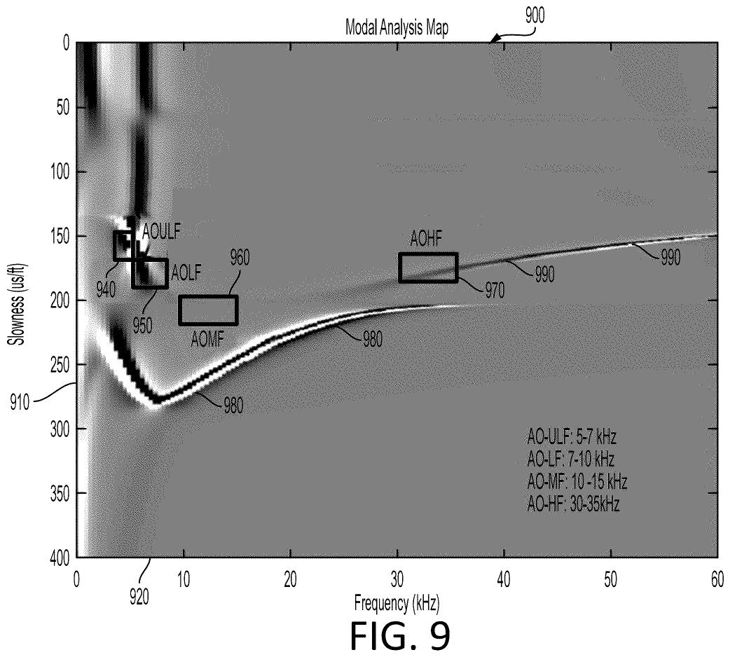

After the eccentricity effect analysis is performed at block 850, processing windows may be generated at block 860. These processing windows may identify data associated with one or more guided wave modes. These processing windows may be used to identify specific portions of data associated with the modal analysis map 900 of FIG. 9, the eccentricity sensitivity map 1000 of FIG. 10, the channel sensitivity map 1100 of FIG. 11, and the response polarity map 1200 of FIG. 12.

After the channel sensitivity analysis is performed at block 855, a response polarity analysis may be performed at block 865. Data from the modeling process 805, processing window data from block 860, and data output from the response polarity analysis block 865 may be used to generate combined multi-frequency acoustic maps at block 870.

FIG. 9 illustrates a modal analysis map generated based on data collected from multiple different stimulus frequencies used by an acoustic sensing device (e.g., a hydrophone array). The modal analysis map 900 of FIG. 9 includes a vertical axis 910 of slowness and a horizontal axis 920 of frequency. Here the stimulus frequencies used by the acoustic sensing device may include frequencies from four different frequency ranges AOULF (5-7 KHz), AOLF (7-10 KHz), AOMF (10-15 KHz), and AOHF (30-35 KHz).

Windows 940, 950, 960, and 970 are windows that may have been selected based on operation of the modeling-based data analysis engine 800 of FIG. 8, for example, at block 860 of FIG. 8. Windows 940, 950, 960, and 970 may be used to identify data that fall into different respective spans of slowness values and frequency values. Note that respective windows shown in FIGS. 10, 11, and 12 may share the respective spans of slowness values and frequency values of FIG. 9.

The modal analysis performed by the modeling process 805 of FIG. 8 (e.g., at blocks 810 and 820) may be used to generate the plot of FIG. 9. In this instance, the modal analysis was performed based on casing that has an out diameter of 9.625 inches. This may include applying a mathematical process to remove fluid modes and tubing signals from a dataset with the intent of only leaving the casing-related wave data. FIG. 9 includes curves that may correspond to modal guided waves. For example, curve 980 may correspond to a tubing guided wave mode and curve 990 may correspond to a casing guided wave mode. FIG. 9 also includes curves near windows 940 and 950 that may correspond to one or more other guided wave modes. Each of these curves may serve as guidelines to understand physical responses of different modes in slowness frequency amplitude map 900.

FIG. 10 illustrates an eccentricity sensitivity map that may have been generated based on the eccentricity sensitivity analysis discussed in respect to FIG. 8. The eccentricity sensitivity map 1000 of FIG. 10 includes a vertical axis 1010 of slowness and a horizontal axis 1020 of frequency. FIG. 10 also includes color/gray scale 1030. When scale 1030 is presented in color, the color of dark blue may be used to represent relatively low eccentricity sensitivity values (e.g., values 0 through 0.18), the colors of light blue through yellow or light orange may be used to identify medium eccentricity values (e.g. values 0.18 through 0.45), and the colors of dark orange through red may be used to identify high eccentricity values (e.g., values 0.45 through 0.6). When scale 1030 is drawn in grayscale, different shades of gray may be used to identify different eccentricity sensitivity values. Note that FIG. 10 includes windows 1040, 1050, 1060, and 1070 that each may correspond to slowness and frequency ranges of windows 940, 950, 960, and 970 of FIG. 9.

FIG. 11 illustrates a channel sensitivity map that may have been generated based on the channel sensitivity analysis discussed in respect to FIG. 8. The channel sensitivity map 1100 of FIG. 11 includes a vertical axis 1110 of slowness and a horizontal axis 1120 of frequency. FIG. 11 also includes color/gray scale 1130. When scale 1130 is presented in color, the color of dark blue may be used to represent relatively low eccentricity sensitivity values (e.g., values 0.5 through 0.64), the colors of light blue through yellow or light orange may be used to identify medium eccentricity values (e.g. values 0.64 through 0.78), and the colors of dark orange through red may be used to identify high eccentricity values (e.g., values 0.78 through 0.82). When scale 1130 is drawn in grayscale, different shades of gray may be used to identify different channel sensitivity values. Note that FIG. 11 includes windows 1140, 1150, 1160, and 1170 that each may correspond to slowness and frequency ranges of windows 940, 950, 960, and 970 of FIG. 9.

FIG. 12 illustrates a response polarity map that may have been generated based on the channel sensitivity analysis discussed in respect to FIG. 8. The response polarity map 1200 of FIG. 12 includes a vertical axis 1210 of slowness and a horizontal axis 1220 of frequency. FIG. 11 also includes color/gray scale 1230. When scale 1230 is presented in color, the color of dark blue may be used to represent a first range of response polarity values (e.g., values −1.0 through −0.33), the color gray may be used to identify medium response polarity values (e.g. values −0.33 through +0.38), and the color red may be used to identify response polarity values (e.g., values +0.38 through +1.0). When scale 1230 is drawn in grayscale, different shades of gray may be used to identify different response polarity values. Note that FIG. 11 includes windows 1240, 1250, 1260, and 1270 that each may correspond to slowness and frequency ranges of windows 940, 950, 960, and 970 of FIG. 9.

Since each of the different windows of FIGS. 9-12 each may span the same ranges of slowness and frequency values and when each of these respective windows are associated with a specific frequency or frequency range, each of these windows may be respectively referred to as windows associated with frequencies LF1, LF2, LF3, and HF1. In such an instance, window of LF1 corresponds to windows 940, 1040, 1140, and 1240 of FIGS. 9-12; window if LF2 corresponds to windows 950, 1050, 1150, and 1250 of FIGS. 9-12; window of LF3 corresponds to windows 960, 1060, 1160, and 1260 of FIGS. 9-12; and window of HF1 corresponds to windows 970, 1070, 1170, and 1270 of FIGS. 9-12. Each of these different frequencies LF1, LF2, LF3, and HF1 may respectively correspond to the frequency ranges of AOULF, AOLF, AOMF, and AOHF discussed above.

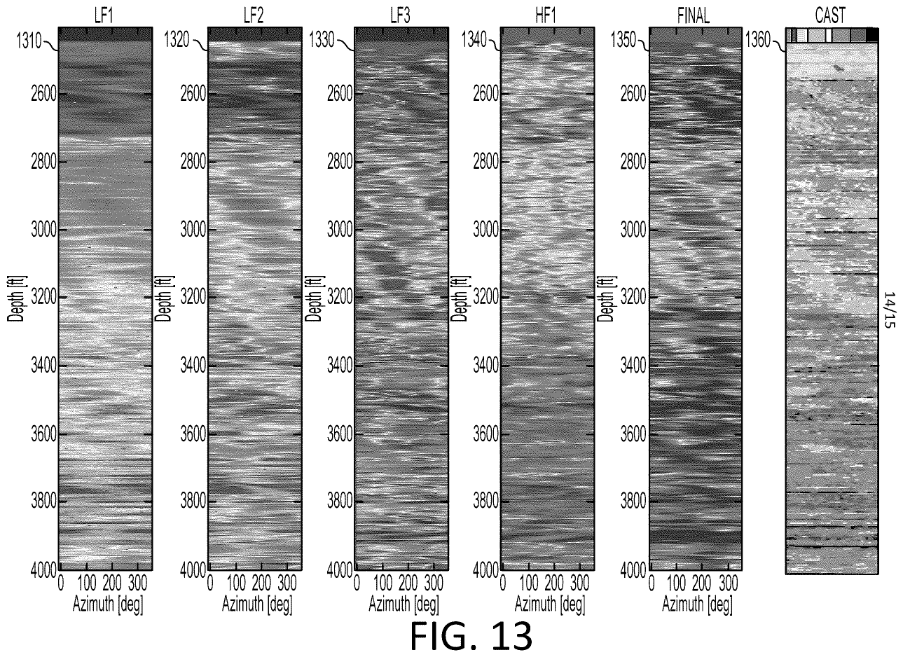

FIG. 13 illustrates how images generated from data associated with different stimulation frequencies may be combined to generate a final or output cement evaluation image. FIG. 13 includes image 1310, image 1320, image 1330, and image 1340 that are combined to generate final or output image 1350. Each of the images of FIG. 13 may provide a two-dimensional mapping of wellbore, azimuth (360 degrees around the wellbore) versus depth. The various mappings of FIGS. 9-12 and portions of data selected based on the selected windows may be used to generate the final cement evaluation map of FIG. 13.

Windows of LF1, LF2, and LF3 may have been chosen because they each have lower than a threshold level of eccentricity values while having a good (channel sensitivity (greater than a threshold level of sensitivity value). The window of HF1 may have been selected because it has good channel sensitivity (greater than the threshold level of sensitivity value). The window of HF1 may have also been selected because energies of higher frequency stimulation signals being known to dissipate rapidly (according to a dissipation profile) in formations that surround the wellbore. Equation 5 below may be used to combine images 1310, 1320, 1330, and 1340 to generate the final or output image 1350.

$${Map}_{final} ( s , f ) = \frac{{Map}_{HF 1} ( s , f )}{{Map}_{LF 1} ( s , f ) * {Map}_{LF 2} ( s , f ) * {Map}_{LF 3} ( s , f )} \qquad Equation 5$$

In some cases, images (1310, 1320, & 1330) associated with relatively lower frequencies (e.g., frequencies of LF1, LF2, & LF3) may be affected more by formation effects or other factors as compared to the higher frequency of HF1. This may be because lower frequency signals may travel more readily than higher frequency signals through formations that surrounds a wellbore. Furthermore, effects of the formation also tend not to be indicative of a cement bonding related condition. Because of this, lower frequency maps may need to be pre-calibrated before performing the combining procedure.

As such, the first four mappings may be eccentricity calibrated maps from four different slowness windows. The final image 1350 more accurately represents actual bonding conditions based on the use of multiple different stimulus frequencies and based on how techniques of the present disclosure mitigate effects that distort information included in sets of collected data.

FIG. 13 also includes image 1360 that may have been collected using a tool that is different from the acoustic array or hydrophone assembly discussed above. This other tool may have been deployed in the wellbore as part of a validation process. For example, this other tool (e.g., a CAST tool) may have been deployed in the center of the wellbore before a set of tubing within which the hydrophone array was deployed in. In some instances, this other tool may measure impedances of the casing or cement casing interface. As such this other tool may collect data that does not include eccentricities or data associated with multiple different transmission modes that could distort a set of collected data. As such the CAST image 1360 may be used as a Gold Standard reference that is used validate the accuracy of the technique disclosed within. Note that details included in image 1350 very closely track details in image 1360. In fact, image 1350 more closely resembles image 1360 than any other image (1310, 1320, 1330, and 1340) of FIG. 13.

The various mappings illustrated figures discussed above are associated with various features of the movement of guided wave modes through mediums. Such mappings include slowness versus frequency mappings (e.g., the map of FIG. 6), modal mappings (e.g., the map of FIG. 9), eccentricity sensitivity mappings (e.g. the map of FIG. 10), channel sensitivity mappings (e.g., the map of FIG. 11), response polarity mappings (e.g., the map of FIG. 12), or cement bond evaluation mappings (e.g., the map of FIG. 13). Each of these different mappings may be referred to as feature mappings from which conditions of a wellbore or wellbore structure can be identified. Determinations made using techniques of the present disclosure may be used to validate integrity of the wellbore (e.g., the integrity of wellbore cement) at any phase of a wellbore's life cycle. Techniques of the present disclosure may be used to identify areas of a wellbore where a repair or plugging operation should be performed. For example, information that identifies the location, the size, and/or scope (e.g., length along a wellbore or volume) of defective cement may be identified and used to direct the wellbore repair or plugging operation. In instances when a determination is made that the wellbore is safe to operation, one or more pumps or valves may be activated to initiate the operation of the wellbore. Such pumps or valves may be configured to move fluids up the wellbore, down the wellbore or both up and down the wellbore.

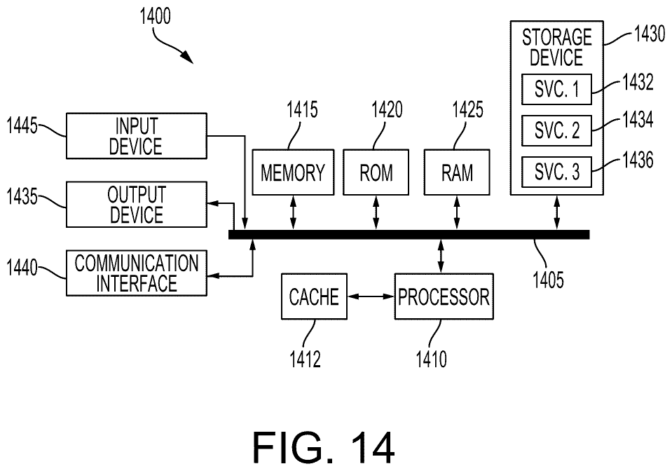

FIG. 14 illustrates an example computing device architecture which can be employed to perform any of the systems and techniques described herein. In some examples, the computing device 1400 architecture can be integrated with tools described herein. The components of the computing device architecture 1400 are shown in electrical communication with each other using a connection 1405, such as a bus. The example computing device architecture 1400 includes a processing unit (CPU or processor) 1410 and a computing device connection 1405 that couples various computing device components including the computing device memory 1415, such as read only memory (ROM) 1420 and random access memory (RAM) 1425, to the processor 1410.

The computing device architecture 1400 can include a cache of high-speed memory connected directly with, in close proximity to, or integrated as part of the processor 1410. The computing device architecture 1400 can copy data from the memory 1415 and/or the storage device 1430 to the cache 1412 for quick access by the processor 1410. In this way, the cache can provide a performance boost that avoids processor 1410 delays while waiting for data. These and other modules can control or be configured to control the processor 1410 to perform various actions. Other computing device memory 1415 may be available for use as well. The memory 1415 can include multiple different types of memory with different performance characteristics. The processor 1410 can include any general-purpose processor and a hardware or software service, such as service 1 1432, service 2 1434, and service 3 1436 stored in storage device 1430, configured to control the processor 1410 as well as a special-purpose processor where software instructions are incorporated into the processor design. The processor 1410 may be a self-contained system, containing multiple cores or processors, a bus, memory controller, cache, etc. A multi-core processor may be symmetric or asymmetric.

To enable user interaction with the computing device architecture 1400, an input device 1445 can represent any number of input mechanisms, such as a microphone for speech, a touch-sensitive screen for gesture or graphical input, keyboard, mouse, motion input, speech and so forth. An output device 1435 can also be one or more of a number of output mechanisms known to those of skill in the art, such as a display, projector, television, speaker device, etc. In some instances, multimodal computing devices can enable a user to provide multiple types of input to communicate with the computing device architecture 1400. The communications interface 1440 can generally govern and manage the user input and computing device output. There is no restriction on operating on any particular hardware arrangement and therefore the basic features here may easily be substituted for improved hardware or firmware arrangements as they are developed.

Storage device 1430 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1425, read only memory (ROM) 1420, and hybrids thereof. The storage device 1430 can include services 1432, 1434, 1436 for controlling the processor 1410. Other hardware or software modules are contemplated. The storage device 1430 can be connected to the computing device connection 1405. In one aspect, a hardware module that performs a particular function can include the software component stored in a computer-readable medium in connection with the necessary hardware components, such as the processor 1410, connection 1405, output device 1435, and so forth, to carry out the function.

For clarity of explanation, in some instances the present technology may be presented as including individual functional blocks including functional blocks comprising devices, device components, steps or routines in a method implemented in software, or combinations of hardware and software.

In some instances, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples and aspects thereof, but those skilled in the art will recognize that the application is not limited thereto. Thus, while illustrative examples and aspects of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, examples and aspects of the systems and techniques described herein can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Methods and apparatus of the disclosure may be practiced in network computing environments with many types of computer system configurations, including personal computers, hand-held devices, multi-processor systems, microprocessor-based or programmable consumer electronics, network PCS, minicomputers, mainframe computers, and the like. Such methods may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Aspects of the present disclosure include:

Aspect 1: A method comprising: performing an analysis on received sensor data to identify one or more acoustic guided wave modes of a wellbore; and identifying a plurality of windows to associate with portions of the received sensor data, wherein each window of the plurality of windows are associated with: a respective frequency range of a plurality of frequency ranges, the plurality of frequency ranges including one or more frequency ranges that include frequencies that are lower frequency ranges than at least one other frequency range that spans one or more frequencies that are greater than the lower frequency ranges, and a respective range of slowness values. This method may also include generating one or more feature mappings for each of the lower frequency ranges; generating a guided wave mapping for the at least one other frequency range; and combining the one more feature mappings for each of the lower frequency ranges with the guided wave mapping for the at least one other frequency range.

Aspect 2: The method of Aspect 1, wherein the one or more feature mappings for each of the lower frequency ranges are combined with the guided wave mapping for the at least one other frequency range based on data provided by a model of a tubing-casing wellbore environment.

Aspect 3: The method of Aspect 2, further comprising: accessing data that identifies at least of a casing or a tubing characteristic; and modeling a/the tubing-casing wellbore environment based on the casing or the tubing characteristic.

Aspect 4: The method of any of Aspects 1 through 3, further comprising: performing an eccentricity sensitivity analysis; performing a channel sensitivity analysis; and performing a polarity analysis, wherein the one or more feature mappings for each of the lower frequency ranges are combined with the guided wave mapping for the at least one other frequency range based on data from the eccentricity sensitivity analysis, data from the channel sensitivity analysis, and data from the polarity analysis.

Aspect 5: The method of any of Aspects 1 through 4, further comprising: determining that the wellbore is safe to operate based on the one or more feature mappings for each of the lower frequency ranges being combined with the guided wave mapping for the at least one other frequency range.

Aspect 6: The method of Aspect 5, further comprising: generating one or more images from data associated with the combination of the one or more feature mappings and the guided wave mapping, wherein the wellbore is placed into operation by activation of one or more pumps or valves according to a/the determination that the wellbore is safe to operate.

Aspect 7: The method of any of Aspects 1 through 6, further comprising: determining a location, a size, or a scope of defective wellbore cement of a wellbore based on an analysis, wherein a repair or a plugging operation is guided based on the determination of the location, the size, or the scope of the defective wellbore cement.

Aspect 8: A non-transitory computer-readable storage medium where one or more processors execute instructions when: performing an analysis on received sensor data to identify one or more acoustic guided wave modes of a wellbore; and identifying a plurality of windows to associate with portions of the received sensor data, wherein each window of the plurality of windows are associated with: a respective frequency range of a plurality of frequency ranges, the plurality of frequency ranges including one or more frequency ranges that include frequencies that are lower frequency ranges than at least one other frequency range that spans one or more frequencies that are greater than the lower frequency ranges, and a respective range of slowness values. The one or more processors may execute the instructions when generating one or more feature mappings for each of the lower frequency ranges; generating a guided wave mapping for the at least one other frequency range; and combining the one or more feature mappings for each of the lower frequency ranges with the guided wave mapping for the at least one other frequency range.

Aspect 9: The non-transitory computer-readable storage medium of Aspect 8, wherein the one or more feature mappings for each of the lower frequency ranges are combined with the guided wave mapping for the at least one other frequency range based on data provided by a model of a tubing-casing wellbore environment.

Aspect 10: The non-transitory computer-readable storage medium of Aspect 9, wherein the one or more processors execute the instructions to: access data that identifies at least of a casing or a tubing characteristic; and model a/the tubing-casing wellbore environment based on the casing or the tubing characteristic.

Aspect 11: The non-transitory computer-readable storage medium of any of Aspects 8 through 10, wherein the one or more processors execute the instructions to: perform an eccentricity sensitivity analysis; perform a channel sensitivity analysis; and perform a polarity analysis, wherein the one or more feature mappings for each of the lower frequency ranges are combined with the guided wave mapping for the at least one other frequency range based on data from the eccentricity sensitivity analysis, data from the channel sensitivity analysis, and data from the polarity analysis.

Aspect 12: The non-transitory computer-readable storage medium of any of Aspects 8 through 11, wherein the one or more processors execute the instructions to: determine that the wellbore is safe to operate based on the one or more feature mappings for each of the lower frequency ranges being combined with the guided wave mapping for the at least one other frequency range.

Aspect 13: The non-transitory computer-readable storage medium of Aspect 12, wherein the one or more processors execute the instructions to: generate one or more images from data associated with the combination of the one or more feature mappings and the guided wave mapping, wherein the wellbore is placed into operation by activation of one or more pumps or valves according to a/the determination that the wellbore is safe to operate.

Aspect 14: The non-transitory computer-readable storage medium of any of Aspects 8 through 13, wherein the one or more processors execute the instructions to: determine a location, a size, or a scope of defective wellbore cement of a wellbore based on an analysis, wherein a repair or a plugging operation is guided based on the determination of the location, the size, or the scope of the defective wellbore cement.

Aspect 15: An apparatus comprising: a memory; and one or more processors that execute instructions out of the memory to: perform an analysis on received sensor data to identify one or more acoustic guided wave modes of a wellbore; and identify a plurality of windows to associate with portions of the received sensor data, wherein each window of the plurality of windows are associated with: a respective frequency range of a plurality of frequency ranges, the plurality of frequency ranges including one or more frequency ranges that include frequencies that are lower frequency ranges than at least one other frequency range that spans one or more frequencies that are greater than the lower frequency ranges, and a respective range of slowness values. The one or more processors may also execute the instructions out of the memory to generate one or more feature mappings for each of the lower frequency ranges; generate a guided wave mapping for the at least one other frequency range; and combine the one or more feature mappings for each of the lower frequency ranges with the guided wave mapping for the at least one other frequency range.

Aspect 16: The apparatus of Aspect 15, wherein the one or more feature mappings for each of the lower frequency ranges are combined with the guided wave mapping for the at least one other frequency range based on data provided by a model of a tubing-casing wellbore environment.

Aspect 17: The apparatus of Aspect 16, wherein the one or more processors execute the instruction out of the memory to: access data that identifies at least of a casing or a tubing characteristic; and model a/the tubing-casing wellbore environment based on the casing or the tubing characteristic.

Aspect 18: The apparatus of any of Aspects 15 through 17, wherein the one or more processors execute the instruction out of the memory to: perform an eccentricity sensitivity analysis; perform a channel sensitivity analysis; and perform a polarity analysis, wherein the one or more feature mappings for each of the lower frequency ranges are combined with the guided wave mapping for the at least one other frequency range based on data from the eccentricity sensitivity analysis, data from the channel sensitivity analysis, and data from the polarity analysis.

Aspect 19: The apparatus of any of Aspects 15 through 18, wherein the one or more processors execute the instruction out of the memory to: determine that the wellbore is safe to operate based on the one or more feature mappings for each of the lower frequency ranges being combined with the guided wave mapping for the at least one other frequency range.

Aspect 20: The apparatus of any of Aspects 15 through 19, further comprising: one or more pumps or valves, wherein the wellbore is placed into operation by activation of the one or more pumps or valves according to a/the determination that the wellbore is safe to operate.

What is claimed is:

1. A method comprising:
performing an analysis on received sensor data to identify one or more acoustic guided wave modes of a wellbore;
identifying a plurality of windows to associate with portions of the received sensor data, wherein each window of the plurality of windows are associated with:
a respective frequency range of a plurality of frequency ranges, the plurality of frequency ranges including one or more frequency ranges that include frequencies that are lower frequency ranges than at least one other frequency range that spans one or more frequencies that are greater than the lower frequency ranges, and
a respective range of slowness values;
generating one or more feature mappings for each of the lower frequency ranges;
generating a guided wave mapping for the at least one other frequency range; and
combining the one more feature mappings for each of the lower frequency ranges with the guided wave mapping for the at least one other frequency range.

2. The method of claim 1, wherein the one or more feature mappings for each of the lower frequency ranges are combined with the guided wave mapping for the at least one other frequency range based on data provided by a model of a tubing-casing wellbore environment.

3. The method of claim 2, further comprising:
accessing data that identifies at least of a casing or a tubing characteristic; and
modeling the tubing-casing wellbore environment based on the casing or the tubing characteristic.

4. The method of claim 1, further comprising:
performing an eccentricity sensitivity analysis;
performing a channel sensitivity analysis; and
performing a polarity analysis, wherein the one or more feature mappings for each of the lower frequency ranges are combined with the guided wave mapping for the at least one other frequency range based on data from the eccentricity sensitivity analysis, data from the channel sensitivity analysis, and data from the polarity analysis.

5. The method of claim 1, further comprising:
determining that the wellbore is safe to operate based on the one or more feature mappings for each of the lower frequency ranges being combined with the guided wave mapping for the at least one other frequency range.

6. The method of claim 5, further comprising:
generating one or more images from data associated with the combination of the one or more feature mappings and the guided wave mapping, wherein the wellbore is placed into operation by activation of one or more pumps or valves according to the determination that the wellbore is safe to operate.

7. The method of claim 1, further comprising:
determining a location, a size, or a scope of defective wellbore cement of a wellbore based on an analysis, wherein a repair or a plugging operation is guided based on the determination of the location, the size, or the scope of the defective wellbore cement.

8. A non-transitory computer-readable storage medium where one or more processors execute instructions when:
performing an analysis on received sensor data to identify one or more acoustic guided wave modes of a wellbore;
identifying a plurality of windows to associate with portions of the received sensor data, wherein each window of the plurality of windows are associated with:
a respective frequency range of a plurality of frequency ranges, the plurality of frequency ranges including one or more frequency ranges that include frequencies that are lower frequency ranges than at least one other frequency range that spans one or more frequencies that are greater than the lower frequency ranges, and
a respective range of slowness values;
generating one or more feature mappings for each of the lower frequency ranges;
generating a guided wave mapping for the at least one other frequency range; and
combining the one or more feature mappings for each of the lower frequency ranges with the guided wave mapping for the at least one other frequency range.

9. The non-transitory computer-readable storage medium of claim 8, wherein the one or more feature mappings for each of the lower frequency ranges are combined with the guided wave mapping for the at least one other frequency range based on data provided by a model of a tubing-casing wellbore environment.

10. The non-transitory computer-readable storage medium of claim 9, wherein the one or more processors execute the instructions to:
access data that identifies at least of a casing or a tubing characteristic; and
model the tubing-casing wellbore environment based on the casing or the tubing characteristic.

11. The non-transitory computer-readable storage medium of claim 8, wherein the one or more processors execute the instructions to:
perform an eccentricity sensitivity analysis;
perform a channel sensitivity analysis; and
perform a polarity analysis, wherein the one or more feature mappings for each of the lower frequency ranges are combined with the guided wave mapping for the at least one other frequency range based on data from the eccentricity sensitivity analysis, data from the channel sensitivity analysis, and data from the polarity analysis.

12. The non-transitory computer-readable storage medium of claim 8, wherein the one or more processors execute the instructions to:
determine that the wellbore is safe to operate based on the one or more feature mappings for each of the lower frequency ranges being combined with the guided wave mapping for the at least one other frequency range.

13. The non-transitory computer-readable storage medium of claim 12, wherein the one or more processors execute the instructions to:
generate one or more images from data associated with the combination of the one or more feature mappings and the guided wave mapping, wherein the wellbore is placed into operation by activation of one or more pumps or valves according to the determination that the wellbore is safe to operate.

14. The non-transitory computer-readable storage medium of claim 8, wherein the one or more processors execute the instructions to:
determine a location, a size, or a scope of defective wellbore cement of a wellbore based on an analysis, wherein a repair or a plugging operation is guided based on the determination of the location, the size, or the scope of the defective wellbore cement.

15. An apparatus comprising:
a memory; and
one or more processors that execute instructions out of the memory to:
perform an analysis on received sensor data to identify one or more acoustic guided wave modes of a wellbore;
identify a plurality of windows to associate with portions of the received sensor data, wherein each window of the plurality of windows are associated with:
a respective frequency range of a plurality of frequency ranges, the plurality of frequency ranges including one or more frequency ranges that include frequencies that are lower frequency ranges than at least one other frequency range that spans one or more frequencies that are greater than the lower frequency ranges, and
a respective range of slowness values;
generate one or more feature mappings for each of the lower frequency ranges;
generate a guided wave mapping for the at least one other frequency range; and
combine the one or more feature mappings for each of the lower frequency ranges with the guided wave mapping for the at least one other frequency range.

16. The apparatus of claim 15, wherein the one or more feature mappings for each of the lower frequency ranges are combined with the guided wave mapping for the at least one other frequency range based on data provided by a model of a tubing-casing wellbore environment.

17. The apparatus of claim 16, wherein the one or more processors execute the instruction out of the memory to:
access data that identifies at least of a casing or a tubing characteristic; and
model the tubing-casing wellbore environment based on the casing or the tubing characteristic.

18. The apparatus of claim 15, wherein the one or more processors execute the instruction out of the memory to:
perform an eccentricity sensitivity analysis;
perform a channel sensitivity analysis; and
perform a polarity analysis, wherein the one or more feature mappings for each of the lower frequency ranges are combined with the guided wave mapping for the at least one other frequency range based on data from the eccentricity sensitivity analysis, data from the channel sensitivity analysis, and data from the polarity analysis.

19. The apparatus of claim 15, wherein the one or more processors execute the instruction out of the memory to:
determine that the wellbore is safe to operate based on the one or more feature mappings for each of the lower frequency ranges being combined with the guided wave mapping for the at least one other frequency range.

20. The apparatus of claim 19, further comprising:
one or more pumps or valves, wherein the wellbore is placed into operation by activation of the one or more pumps or valves according to the determination that the wellbore is safe to operate.
